(19) United States
(12) Patent Application Publication
(10) Pub. No.: US 2023/0303372 A1
(43) Pub. Date: Sep. 28, 2023

(54) FORKLIFT DRIVE UNIT AND FORKLIFT

(71) Applicant: EXEDY Corporation, Osaka (JP)

(72) Inventors: Hiroshi KAMIMURA, Osaka (JP); Takashi ARIMOTO, Osaka (JP); Yoshihiro UMEDA, Osaka (JP)

(21) Appl. No.: 18/172,440

(22) Filed: Feb. 22, 2023

(30) Foreign Application Priority Data
Mar. 22, 2022 (JP) 2022-045562

(51) Int. Cl. B66F 9/075; B60L 15/20

(52) U.S. Cl. CPC B66F 9/07572; B60L 15/20; B60L 2200/42

(57) ABSTRACT

A forklift drive unit is configured to be installed in a forklift. The forklift drive unit includes an electric motor and a transmission. The electric motor is configured to drive and rotate a drive wheel. The transmission is configured to change a speed of rotation of the electric motor at a variable gear ratio.

### CROSS-REFERENCE TO RELATED APPLICATIONS

This application claims priority to Japanese Patent Application No. 2022-045562 filed Mar. 22, 2022. The entire contents of that application are incorporated by reference herein in their entirety.

### TECHNICAL FIELD

The present invention relates to a forklift drive unit and a forklift.

### BACKGROUND ART

Electric forklifts do not emit exhaust gas and are quiet as well. Because of this, the electric forklifts are widely used in the interior of factories, warehouses, and so forth. The electric forklifts include an electric motor as a drive source and travels when the electric motor drives drive wheels (Japan Laid-open Patent Application Publication No. 2013-212918).

However, the electric forklifts have a drawback of inferiority in driving force and speed when compared to internal combustion engine forklifts. In view of this, it is an object of the present invention to provide an electric forklift enabling enhancement in driving force and speed.

### BRIEF SUMMARY

A forklift drive unit according to a first aspect of the present invention is configured to be installed in a forklift. The forklift drive unit includes an electric motor and a transmission. The electric motor is configured to drive and rotate a drive wheel. The transmission is configured to change a speed of rotation of the electric motor at a variable gear ratio.

According to the configuration, the gear ratio is made variable by the transmission, whereby enhancement in driving force of the electric motor and enhancement in speed are enabled.

Preferably, the electric motor includes a first output shaft extending to a first side in an axial direction. The transmission includes a plurality of gear trains and a switch part. The switch part is configured to switch a power transmission path between the plurality of gear trains.

Preferably, the switch part is a multi-plate clutch.

Preferably, the switch part is disposed in an overlapping position with the electric motor as seen in a plan view.

Preferably, the transmission includes an input shaft and a supply pathway. The input shaft supports the switch part. The input shaft extends in the axial direction. The supply pathway extends inside the input shaft in the axial direction. The supply pathway includes an inlet portion provided in an end of the input shaft that is disposed on a second side in the axial direction.

Preferably, the plurality of gear trains include a first gear train and a second gear train lesser in gear ratio than the first gear train. The first gear train is disposed on the first side of the second gear train in the axial direction.

Preferably, the switch part is disposed between the first and second gear trains in the axial direction.

Preferably, the plurality of gear trains include a first gear train and a second gear train. The switch part includes a first clutch and a second clutch. The first clutch is configured to switch the power transmission path to the first gear train. The second clutch is configured to switch the power transmission path to the second gear train. The transmission includes a first input shaft and a second input shaft. The first input shaft extends in the axial direction. The first input shaft receives the first clutch attached thereto. Besides, the second input shaft extends in the axial direction. The second input shaft receives the second clutch attached thereto.

Preferably, the first input shaft is disposed in front of the first output shaft. The second input shaft is disposed behind the first output shaft.

Preferably, the transmission includes a second output shaft to which a power is transmitted through the first or second gear train. The second output shaft is disposed between the first and second input shafts in a back-and-forth direction.

Preferably, the second output shaft is disposed below the first and second input shafts.

Preferably, the transmission includes a plurality of planetary gear mechanisms.

Preferably, the transmission is disposed below the electric motor.

A forklift drive unit according to a second aspect of the present invention is configured to be installed in a forklift. The forklift drive unit includes an electric motor and a torque converter. The electric motor is configured to drive and rotate a drive wheel. The torque converter is configured to amplify a torque of the electric motor.

A forklift according to a third aspect of the present invention includes the forklift drive unit configured as any of the above, a lift device, and a drive wheel. The drive wheel is configured to be driven and rotated by the forklift drive unit.

Overall, according to the present invention, enhancement in driving force and speed is enabled.

### BRIEF DESCRIPTION OF THE DRAWINGS

FIG. 1 is a side view of a forklift.

FIG. 2 is a schematic diagram of a drive unit.

FIG. 3 is a side view of the drive unit.

FIG. 4 is a cross-sectional view of FIG. 3 taken along line IV-IV.

FIG. 5 is a schematic diagram of a drive unit according to modifications.

FIG. 6 is a schematic diagram of a drive unit according to another modification.

FIG. 7 is a schematic diagram of a drive unit according to yet another modification.

FIG. 8 is a schematic diagram of the drive unit according to the yet another modification.

FIG. 9 is a schematic diagram of a drive unit according to still another modification.

FIG. 10 is a side view of the drive unit according to the still another modification.

FIG. 11 is a schematic diagram of a drive unit according to a further still another modification.

### DETAILED DESCRIPTION

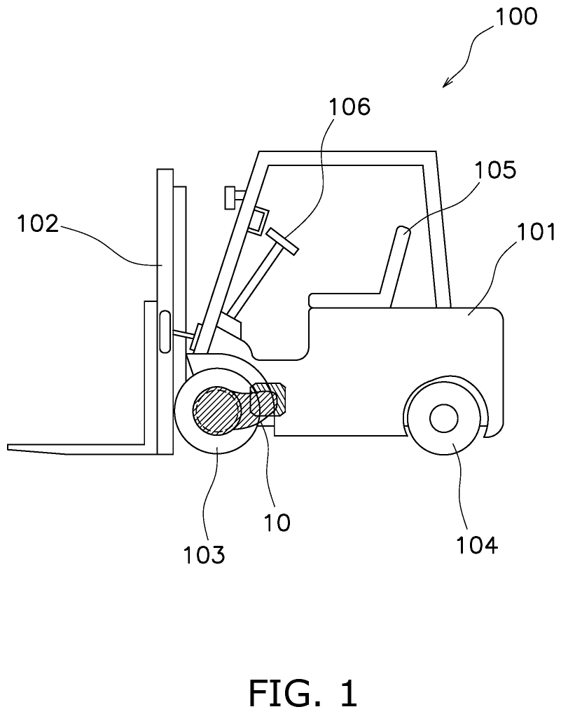

A forklift drive unit and a forklift equipped therewith according to the present preferred embodiment will be hereinafter explained with reference to drawings. FIG. 1 is a side view of the forklift. It should be noted that in the following explanation, the term “axial direction” refers to an extending direction of a rotational axis of an electric motor. Besides, the terms “front” and “rear” mean the front side and the rear side with reference to a vehicle body of the forklift. It should be noted that in FIG. 1, the left side corresponds to the front side, whereas the right side corresponds to the rear side.

[Forklift]

As shown in FIG. 1, a forklift 100 includes a vehicle body 101, a lift device 102, a pair of drive wheels 103, and a drive unit 10. Besides, the forklift 100 includes a pair of driven wheels 104, a seat 105, an operating part 106, and so forth. It should be noted that in the present preferred embodiment, the drive wheels 103 are front wheels, whereas the driven wheels 104 are rear wheels.

The forklift 100 is an electric forklift including an electric motor as a drive source. It should be noted that the forklift 100 does not include any engine. Besides, the forklift 100 includes a battery (not shown in the drawings) as a power supply.

The forklift 100 is enabled to perform a variety of works, including loading of a cargo, by the lift device 102. The lift device 102 is disposed in front of the vehicle body 101 and is attached to the vehicle body 101. The drive wheels 103 are attached to a front part of the vehicle body 101. The driven wheels 104 are attached to a rear part of the vehicle body 101.

[Drive Unit]

The drive unit 10 is configured to be installed in the forklift. The drive unit 10 is disposed inside the vehicle body 101. The drive unit 10 is disposed in the front part of the vehicle body 101. The drive unit 10 is configured to drive the drive wheels 103.

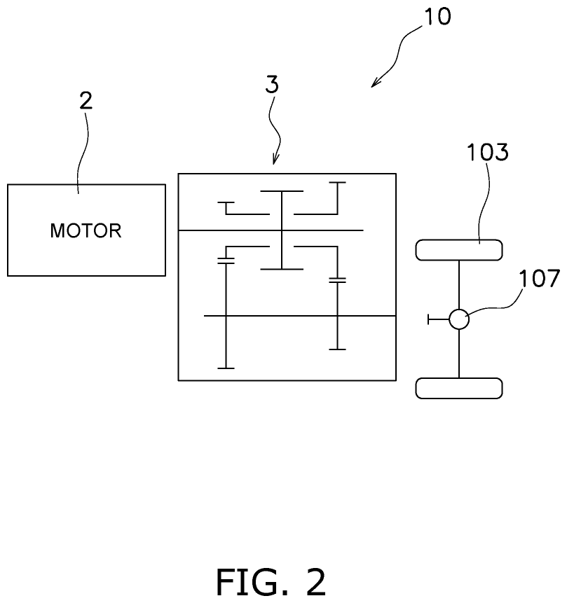

FIG. 2 is a schematic diagram of the drive unit. As shown in FIG. 2, the drive unit 10 is configured to drive and rotate the drive wheels 103. When described in detail, the drive unit 10 outputs a driving force to the pair of drive wheels 103 through a differential gear 107.

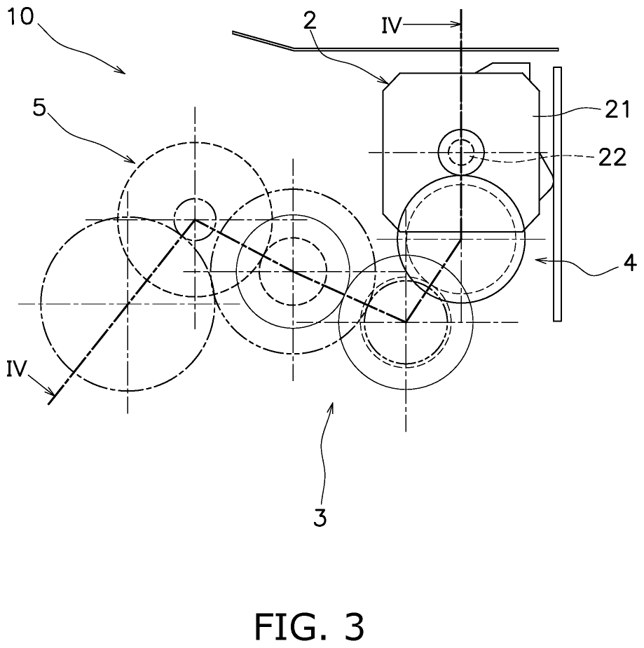

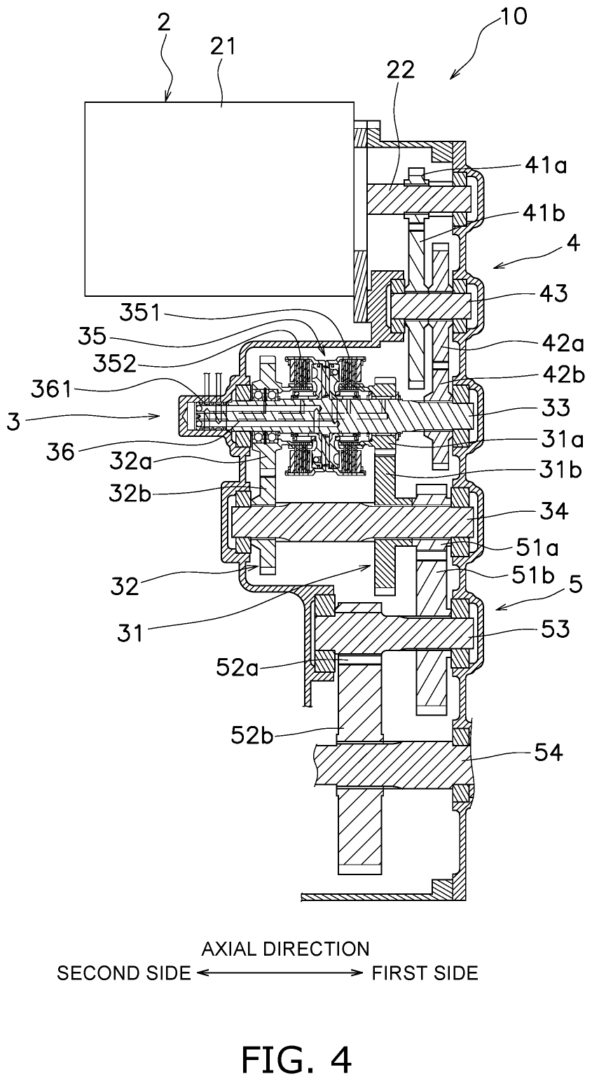

FIG. 3 is a side view of the drive unit, whereas FIG. 4 is a cross-sectional view of FIG. 3 taken along line IV-IV It should be noted that FIG. 4 omits cross-sectional illustration of the electric motor. Besides, in FIG. 3, the left side represents the front side, whereas the right side represents the rear side. As shown in FIGS. 3 and 4, the drive unit 10 includes an electric motor 2, a transmission 3, a first reducer mechanism 4, and a second reducer mechanism 5.

[Electric Motor]

The electric motor 2 is configured to drive and rotate the drive wheels 103. The electric motor 2 is driven when supplied with electricity from the battery. The electric motor 2 includes a motor body 21 and a first output shaft 22.

The motor body 21 includes a rotor (not shown in the drawings) and a stator (not shown in the drawings). The stator is non-rotatable together with a motor case. The rotor is disposed to be rotatable.

The first output shaft 22 extends from the motor body 21 to a first side in the axial direction. The first output shaft 22 is unitarily rotated with the rotor. It should be noted that the first side in the axial direction specifically refers to the right side in FIG. 4. On the other hand, a second side in the axial direction means an opposite side to the first side in the axial direction, and specifically, refers to the left side in FIG. 4.

[Transmission]

The transmission 3 is configured to change the rotational speed of the electric motor 2 at a variable gear ratio. For example, the transmission 3 is a manual transmission. It should be noted that the transmission 3 can be an automatic transmission, and more specifically, can be a CVT (Continuously Variable Transmission).

As shown in FIG. 4, the transmission 3 includes two gear trains. Specifically, the transmission 3 includes a first gear train 31 and a second gear train 32. Each of the first and second gear trains 31 and 32 includes a plurality of gears (e.g., a pair of gears). Specifically, the first gear train 31 includes a first drive gear 31a and a first driven gear 31b. The first drive gear 31a and the first driven gear 31b are meshed with each other. On the other hand, the second gear train 32 includes a second drive gear 32a and a second driven gear 32b. The second drive gear 32a and the second driven gear 32b are meshed with each other.

The transmission 3 transmits a power (mechanical power), outputted from the electric motor 2, to the drive wheels 103 through either the first gear train 31 or the second gear train 32. Thus, either the first gear train 31 or the second gear train 32 is selectable by the transmission 3, whereby the gear ratio is made variable.

The first gear train 31 is disposed on the first side of the second gear train 32 in the axial direction. The first gear train 31 is greater in gear ratio than the second gear train 32. When described in detail, the first drive gear 31a is lesser in diameter than the second drive gear 32a. On the other hand, the first driven gear 31b is greater in diameter than the second driven gear 32b.

The transmission 3 includes an input shaft 33 and a second output shaft 34. The input shaft 33 and the second output shaft 34 extend in the axial direction. The first and second drive gears 31a and 32a are attached to the input shaft 33. The first and second drive gears 31a and 32a are rotatable relative to the input shaft 33. The first and second driven gears 31b and 32b are attached to the second output shaft 34. The first and second driven gears 31b and 32b are unitarily rotated with the second output shaft 34.

The transmission 3 includes a switch part 35. The switch part 35 is supported by the input shaft 33. The switch part 35 is unitarily rotated with the input shaft 33. The switch part 35 is configured to switch a power transmission path to either the first gear train 31 or the second gear train 32. It should be noted that a wet-type multi-plate clutch can be employed as the switch part 35.

The switch part 35 is actuated when supplied with a hydraulic fluid. Specifically, the switch part 35 includes a first clutch 351 and a second clutch 352.

When the first clutch 351 is turned to a clutch-on state, transmission of the power is made through the first gear train 31. Speaking in detail, when the first clutch 351 is turned to the clutch-on state, the first drive gear 31a is unitarily rotated with the input shaft 33. As a result, the power, outputted from the input shaft 33, is transmitted to the second output shaft 34 through the first gear train 31. In other words, the first clutch 351 is configured to switch the power transmission path to the first gear train 31.

When the second clutch 352 is turned to the clutch-on state, transmission of the power is made through the second gear train 32. Speaking in detail, when the second clutch 352 is turned to the clutch-on state, the second drive gear 32a is unitarily rotated with the input shaft 33. As a result, the power, outputted from the input shaft 33, is transmitted to the second output shaft 34 through the second gear train 32. In other words, the second clutch 352 is configured to switch the power transmission path to the second gear train 32.

The transmission 3 includes a supply pathway 36. The supply pathway 36 extends inside the input shaft 33 in the axial direction. The supply pathway 36 is configured to supply the hydraulic fluid (e.g., hydraulic oil) to the switch part 35. Each of the first and second clutches 351 and 352 in the switch part 35 is actuated when supplied with the hydraulic fluid through the supply pathway 36.

When described in detail, the supply pathway 36 includes a first supply pathway and a second supply pathway. The first clutch 351 is turned to the clutch-on state when supplied with the hydraulic fluid through the first supply pathway. On the other hand, the second clutch 352 is turned to the clutch-on state when supplied with the hydraulic fluid through the second supply pathway.

The supply pathway 36 includes an inlet portion 361. The hydraulic fluid is supplied to the interior of the supply pathway 36 through the inlet portion 361. The inlet portion 361 is disposed in one of the ends of the input shaft 33, i.e., the end located on the second side in the axial direction. The inlet portion 361 is joined to a pipe or so forth for supplying the hydraulic fluid to the interior of the supply pathway 36.

The transmission 3 is disposed below the electric motor 2. When described in detail, the switch part 35 and the input shaft 33 in the transmission 3 are disposed below the electric motor 2. In a plan view, the transmission 3 is disposed to overlap with the electric motor 2. When described in detail, in the plan view, the switch part 35 is disposed to overlap with the electric motor 2. It should be noted that the input shaft 33 in the transmission 3 is disposed below the second output shaft 34. The term “plan view” herein means a state of the forklift 100 seen from above.

The switch part 35 in the transmission 3 is disposed axially between the first and second gear trains 31 and 32. In other words, the first gear train 31 is disposed on the first side of the switch part 35 in the axial direction, whereas the second gear train 32 is disposed on the second side of the switch part 35 in the axial direction.

In the plan view, the second gear train 32 is disposed to overlap with the electric motor 2. On the other hand, the first gear train 31 does not overlap with the electric motor 2 in the plan view.

[First Reducer Mechanism]

The first reducer mechanism 4 is configured to reduce the rotational speed of the electric motor 2 and output the speed-reduced rotation to the transmission 3. The first reducer mechanism 4 includes third and fourth drive gears 41a and 42a, third and fourth driven gears 41b and 42b, and a first support shaft 43.

The first support shaft 43 extends in the axial direction. The first support shaft 43 is disposed below the first output shaft 22. It should be noted that in the present preferred embodiment, the first support shaft 43 is disposed directly below the first output shaft 22. The input shaft 33 is disposed below the first support shaft 43.

The third drive gear 41a and the third driven gear 41b are meshed with each other. The third drive gear 41a is lesser in number of teeth than the third driven gear 41b. The third drive gear 41a is attached to the first output shaft 22. The third drive gear 41a is unitarily rotated with the first output shaft 22. The third driven gear 41b is attached to the first support shaft 43. The third driven gear 41b is unitarily rotated with the first support shaft 43.

The fourth drive gear 42a and the fourth driven gear 42b are meshed with each other. The fourth drive gear 42a is greater in number of teeth than the fourth driven gear 42b. It should be noted that an increase ratio between the fourth drive gear 42a and the fourth driven gear 42b is lesser than a reduction ratio between the third drive gear 41a and the third driven gear 41b.

The fourth drive gear 42a is attached to the first support shaft 43. The fourth drive gear 42a is unitarily rotated with the first support shaft 43. The fourth drive gear 42a is lesser in diameter than the third driven gear 41b. The fourth drive gear 42a is disposed on the first side of the third driven gear 41b in the axial direction.

The fourth driven gear 42b is attached to the input shaft 33. The fourth driven gear 42b is unitarily rotated with the input shaft 33. The fourth driven gear 42b is greater in diameter than the first drive gear 31a. The fourth driven gear 42b is disposed on the first side of the first drive gear 31a in the axial direction. The third driven gear 41b is disposed axially between the first drive gear 31a and the fourth driven gear 42b.

In the first reducer mechanism 4, the power is sequentially transmitted in the order of the third drive gear 41a, the third driven gear 41b, the first support shaft 43, the fourth drive gear 42a, and the fourth driven gear 42b.

[Second Reducer Mechanism]

The second reducer mechanism 5 is configured to reduce the rotational speed of the transmission 3 and output the speed-reduced rotation to the drive wheel 103 side. The second reducer mechanism 5 is disposed in front of the transmission 3. The second reducer mechanism 5 includes fifth and sixth drive gears 51a and 52a, fifth and sixth driven gears 51b and 52b, and second and third support shafts 53 and 54.

The second and third support shafts 53 and 54 extend in the axial direction. The second support shaft 53 is disposed above the second output shaft 34. The third support shaft 54 is disposed below the second support shaft 53.

The fifth drive gear 51a and the fifth driven gear 51b are meshed with each other. The fifth drive gear 51a is lesser in number of teeth than the fifth driven gear 51b. The fifth drive gear 51a is lesser in diameter than the first driven gear 31b. The fifth drive gear 51a is attached to the second output shaft 34. The fifth drive gear 51a is unitarily rotated with the second output shaft 34. The fifth driven gear 51b is attached to the second support shaft 53. The fifth driven gear 51b is unitarily rotated with the second support shaft 53.

The sixth drive gear 52a and the sixth driven gear 52b are meshed with each other. The sixth drive gear 52a is lesser in number of teeth than the sixth driven gear 52b. The sixth drive gear 52a is lesser in diameter than the fifth driven gear 51b. The sixth drive gear 52a is disposed on the second side of the fifth driven gear 51b in the axial direction.

The sixth drive gear 52a is integrated with the second support shaft 53. It should be noted that the sixth drive gear 52a can be provided as a member separated from the second support shaft 53 and can be attached to the second support shaft 53 so as to be unitarily rotated therewith.

The sixth driven gear 52b is attached to the third support shaft 54. The sixth driven gear 52b is unitarily rotated with the third support shaft 54.

In the second reducer mechanism 5, the power is sequentially transmitted in the order of the fifth drive gear 51a, the fifth driven gear 51b, the second support shaft 53, the sixth drive gear 52a, the sixth driven gear 52b, and the third support shaft 54.

[Modifications]

One preferred embodiment of the present invention has been explained above. However, the present invention is not limited to the above, and a variety of changes can be made without departing from the gist of the present invention.

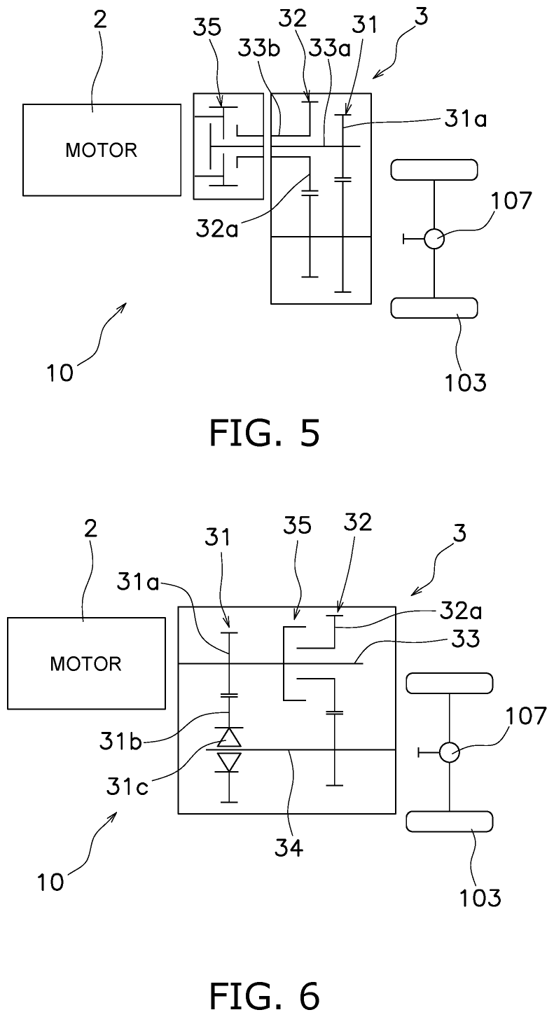

(a) In the preferred embodiment described above, the switch part 35 is disposed between the first and second gear trains 31 and 32; however, the configuration of the transmission 3 is not limited to this. For example, as shown in FIG. 5, the switch part 35 may not be disposed between the first and second gear trains 31 and 32. In this case, for instance, an electromagnetic clutch can be employed as the switch part 35.

(b) In the preferred embodiment described above, the first and second drive gears 31a and 32a are attached to the common shaft; however, the configuration of the transmission 3 is not limited to this. For example, as shown in FIG. 5, the first and second drive gears 31a and 32a can be attached to shafts different from each other, respectively.

When described in detail, the transmission 3 includes first and second input shafts 33a and 33b. Here, the first drive gear 31a is attached to the first input shaft 33a. The first drive gear 31a is unitarily rotated with the first input shaft 33a. The second drive gear 32a is attached to the second input shaft 33b. The second drive gear 32a is unitarily rotated with the second input shaft 33b.

The switch part 35 switches the power transmission path for the power outputted from the electric motor 2 to either the first input shaft 33a or the second input shaft 33b.

(c) In the preferred embodiment described above, the switch part 35 includes two clutches composed of the first and second clutches 351 and 352; however, the configuration of the switch part 35 is not limited to this. For example, the switch part 35 can include only one clutch as exemplified in FIG. 6. In this case, the first gear train 31 includes a one-way clutch 31c. Besides, the first drive gear 31a is unitarily rotated with the input shaft 33. It should be noted that the second drive gear 32a is rotatable relative to the input shaft 33.

The one-way clutch 31c is attached to the second output shaft 34. The first driven gear 31b is attached to the second output shaft 34 through the one-way clutch 31c. The one-way clutch 31c transmits the power, inputted thereto from the first driven gear 31b, to the second output shaft 34 but does not transmit the power, inputted thereto from the second output shaft 34, to the first driven gear 31b.

In the present modification, when the only one clutch in the switch part 35 is in the clutch-off state, transmission of the power of the electric motor 2 is made through the first gear train 31. Contrarily, when the only one clutch in the switch part 35 is in the clutch-on state, the power of the electric motor 2 is made through the second gear train 32.

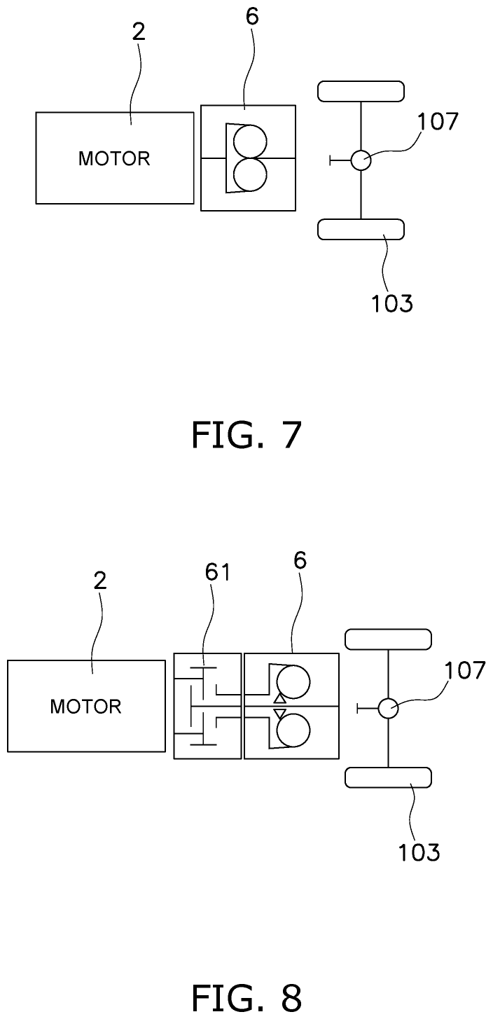

(d) As shown in FIG. 7, the drive unit 10 can include a torque converter 6 instead of the transmission 3. The torque converter 6 is configured to amplify the torque generated by the electric motor 2. When described in detail, the torque converter 6 includes a cover, an impeller, a turbine, and a stator. The torque generated by the electric motor 2 is transmitted to the cover and the impeller and is then transmitted therefrom to the turbine through a hydraulic fluid (e.g., hydraulic oil).

It should be noted that as shown in FIG. 8, the drive unit 10 can include a switch part 61. The switch part 61 switches, as the path for transmitting the power generated by the electric motor 2, between a path for transmitting the power through the torque converter 6 and a path for transmitting the power without through the torque converter 6.

(e) In the preferred embodiment described above, the wet-type multi-plate clutch is employed as the switch part 35; however, the configuration of the switch part 35 is not limited to this. A dry-type multi-plate clutch, a dog clutch, a cam clutch, an electromagnetic clutch, or so forth can be employed as the switch part 35.

(f) In the preferred embodiment described above, the first and second clutches 351 and 352 are attached to the common shaft; however, the configuration of the transmission 3 is not limited to this. For example, the first and second clutches 351 and 352 can be attached to shafts different from each other, respectively. According to the configuration, the transmission 3 can be made compact in the axial direction. The modification will be hereinafter explained in detail.

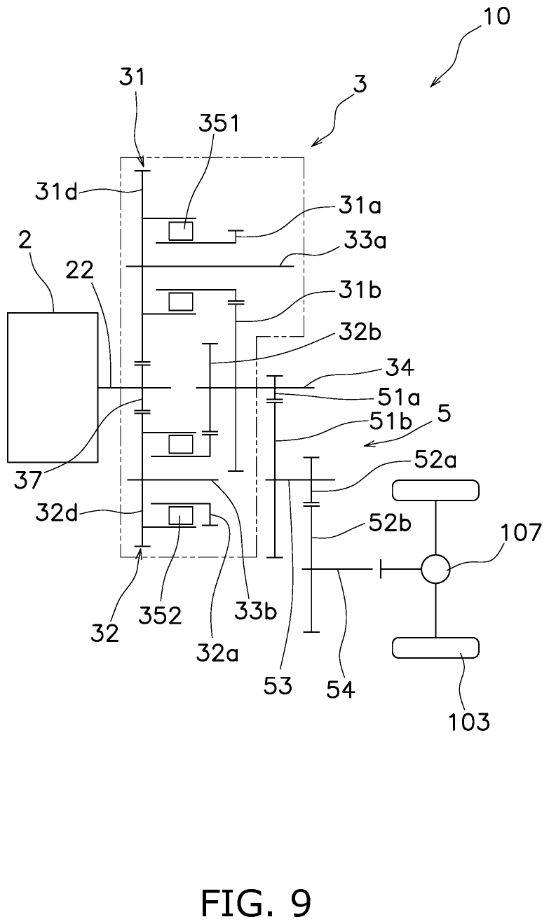

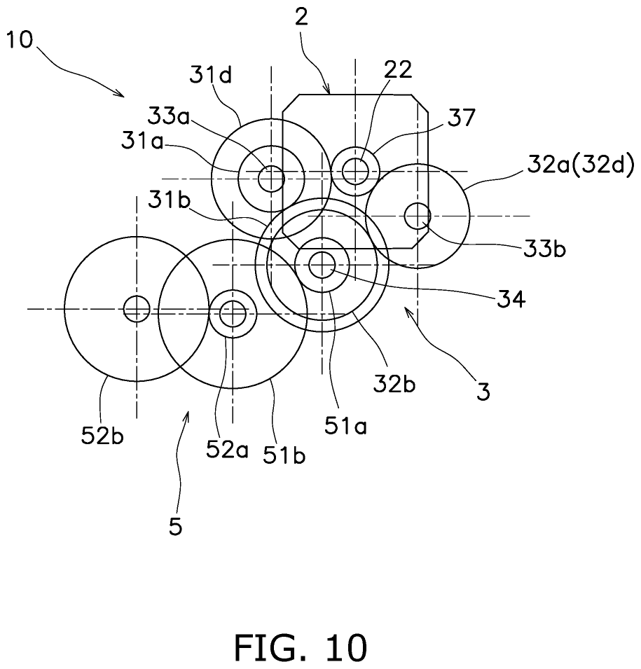

As shown in FIGS. 9 and 10, the transmission 3 includes the first and second input shafts 33a and 33b. The first clutch 351 is attached to the first input shaft 33a. The second clutch 352 is attached to the second input shaft 33b.

The first and second input shafts 33a and 33b extend such that the axes thereof are different from each other. The first and second input shafts 33a and 33b extend in parallel to each other. The first and second input shafts 33a and 33b extend in the axial direction.

The first and second input shafts 33a and 33b extend in parallel to the first output shaft 22. The first input shaft 33a is disposed in front of the first output shaft 22. The second input shaft 33b is disposed behind the first output shaft 22. The second output shaft 34 is disposed between the first and second input shafts 33a and 33b in a back-and-forth direction. It should be noted that the second output shaft 34 is disposed in front of the first output shaft 22. The second output shaft 34 is disposed below the first and second input shafts 33a and 33b. It should be noted that in FIG. 10, the left side represents the front side, whereas the right side represents the rear side.

The transmission 3 includes an input gear 37. The input gear 37 is attached to the first output shaft 22 so as to be unitarily rotated therewith. The first gear train 31 further includes a first transmission gear 31d. The second gear train 32 further includes a second transmission gear 32d. The first and second transmission gears 31d and 32d are meshed with the input gear 37.

The first transmission gear 31d is attached to the first input shaft 33a so as to be unitarily rotatable therewith. Besides, the first clutch 351 is attached to the first input shaft 33a. The second transmission gear 32d is attached to the second input shaft 33b so as to be unitarily rotatable therewith. Besides, the second clutch 352 is attached to the second input shaft 33b.

The first drive gear 31a is attached to the first input shaft 33a so as to be rotatable relative thereto. When the first clutch 351 is turned to the clutch-on state, the first drive gear 31a is unitarily rotated with the first input shaft 33a. As a result, the power, inputted to the first gear 37, is transmitted therefrom to the second output shaft 34 through the first gear train 31. It should be noted that the second clutch 352 is in the clutch-off state.

The second drive gear 32a is attached to the second input shaft 33b so as to be rotatable relative thereto. When the second clutch 352 is turned to the clutch-on state, the second drive gear 32a is unitarily rotated with the second input shaft 33b. As a result, the power, inputted to the input gear 37, is transmitted therefrom to the second output shaft 34 through the second gear train 32. It should be noted that the first clutch 351 is in the clutch-off state.

The first gear train 31 is greater in gear ratio than the second gear train 32. When described in detail, the first transmission gear 31d is greater in diameter than the second transmission gear 32d. Besides, the first drive gear 31a is lesser in diameter than the second drive gear 32a. Furthermore, the first driven gear 31b is greater in diameter than the second driven gear 32b. It should be noted that in FIG. 9, due to limitations of the drawing, the second drive gear 32a is depicted to be lesser in diameter than the second transmission gear 32d; however, in fact, the second drive gear 32a is equal in diameter to the second transmission gear 32d.

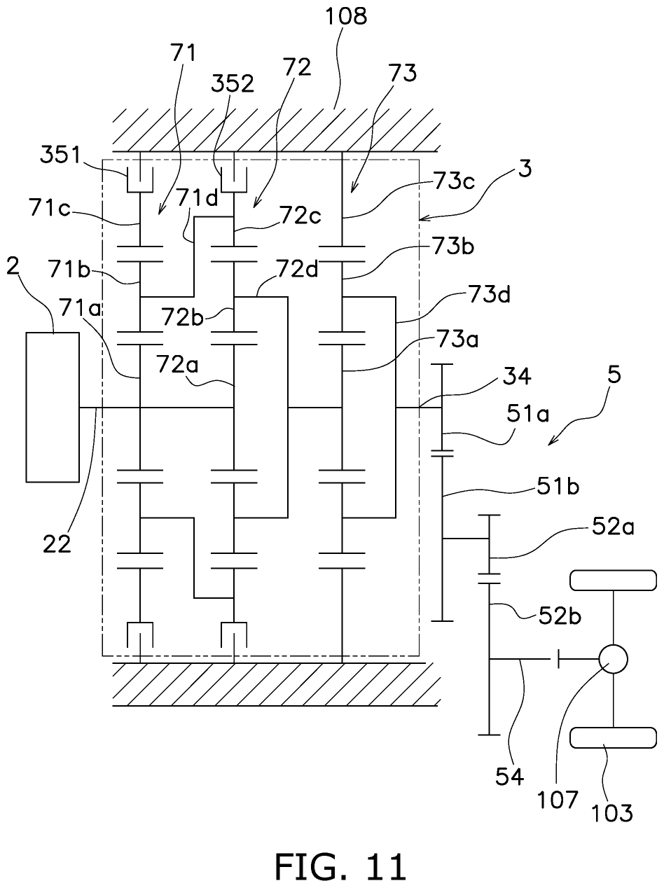

(g) As shown in FIG. 11, the transmission 3 can include a plurality of planetary gear mechanisms. When described in detail, the transmission 3 includes a first planetary gear mechanism 71, a second planetary gear mechanism 72, and a third planetary gear mechanism 73. Besides, the transmission 3 includes the first and second clutches 351 and 352.

The first planetary gear mechanism 71 includes a first sun gear 71a, a plurality of first planet gears 71b, a first ring gear 71c, and a first carrier 71d.

The first sun gear 71a is configured to be unitarily rotated with the first output shaft 22. Each first planet gear 71b is configured to be meshed with the first sun gear 71a. Each first planet gear 71b is configured to be revolved around the first sun gear 71a. In other words, each first planet gear 71b is configured to be circulated around the first output shaft 22. Besides, each first planet gear 71b is configured to be rotated about the axis thereof.

The first ring gear 71c is an internal gear and is meshed with each first planet gear 71b. The first ring gear 71c is configured to be rotated about the first output shaft 22. The first clutch 351 causes coupling between the first ring gear 71c and a stationary part 108 (e.g., a frame, etc.) and releases the coupling. In other words, when the first clutch 351 is turned to the clutch-on state, the first clutch 351 causes coupling between the first ring gear 71c and the stationary part 108, whereby the first ring gear 71c is made non-rotatable. Contrarily, when the first clutch 351 is turned to the clutch-off state, the first clutch 351 releases the coupling between the first ring gear 71c and the stationary part 108, whereby the first ring gear 71c is made rotatable.

The first carrier 71d supports each first planet gear 71b. Each first planet gear 71b is enabled to rotate about the axis thereof, while being supported by the first carrier 71d. The first carrier 71d is configured to be rotated about the first output shaft 22.

The second planetary gear mechanism 72 includes a second sun gear 72a, a plurality of second planet gears 72b, a second ring gear 72c, and a second carrier 72d. On the other hand, the third planetary gear mechanism 73 includes a third sun gear 73a, a plurality of third planet gears 73b, a third ring gear 73c, and a third carrier 73d. It should be noted that the second and third planetary gear mechanisms 72 and 73 are identical in basic configuration to the first planetary gear mechanism 71; hence, the second and third planetary gear mechanisms 72 and 73 will be explained only regarding components thereof different from those of the first planetary gear mechanism 71 without being explained in detail regarding the other components thereof.

The second sun gear 72a is configured to be unitarily rotated with the first output shaft 22. The second ring gear 72c is configured to be unitarily rotated with the first carrier 71d. The second clutch 352 causes coupling between the second ring gear 72c and the stationary part 108 and releases the coupling. In other words, when the second clutch 352 is turned to the clutch-on state, the second clutch 352 causes coupling between the second ring gear 72c and the stationary part 108, whereby the second ring gear 72c is made non-rotatable. Contrarily, when the second clutch 352 is turned to the clutch-off state, the second clutch 352 releases the coupling between the second ring gear 72c and the stationary part 108, whereby the second ring gear 72c is made rotatable.

The third sun gear 73a is configured to be unitarily rotated with the second carrier 72d. The third ring gear 73c is fixed to the stationary part 108 or so forth, and hence, is disposed to be non-rotatable. The third carrier 73d is configured to be unitarily rotated with the second output shaft 34.

The transmission 3 according to the present modification enables two power transmission paths. A first one of the power transmission paths is enabled by turning the first clutch 351 to the clutch-off state so as to make the first ring gear 71c rotatable and by turning the second clutch 352 to the clutch-on state so as to make the second ring gear 72c non-rotatable.

In the first one of the power transmission paths, the power generated by the electric motor 2 is transmitted to the second sun gear 72a in the second planetary gear mechanism 72 through the first output shaft 22. Then, the power is sequentially transmitted in the order of the second sun gear 72a, the second planet gears 72b, and the second carrier 72d and is then transmitted from the second carrier 72d to the third sun gear 73a in the third planetary gear mechanism 73.

A second one of the power transmission paths is enabled by turning the first clutch 351 to the clutch-on state so as to make the first ring gear 71c non-rotatable and by turning the second clutch 352 to the clutch-off state so as to make the second ring gear 72c rotatable.

In the second one of the power transmission paths, the power generated by the electric motor 2 is transmitted to both the first sun gear 71a in the first planetary gear mechanism 71 and the second sun gear 72a in the second planetary gear mechanism 72 through the first output shaft 22.

In the first planetary gear mechanism 71, the power is sequentially transmitted in the order of the first sun gear 71a, the first planet gears 71b, and the first carrier 71d and is then transmitted from the first carrier 71d to the second ring gear 72c in the second planetary gear mechanism 72.

In the second planetary gear mechanism 72, the power is inputted thereto through the second sun gear 72a and the second ring gear 72c. The power, transmitted to each of the second sun gear 72a and the second ring gear 72c, is transmitted to the second carrier 72d through the second planet gears 72b and is then transmitted from the second carrier 72d to the third sun gear 73a in the third planetary gear mechanism 73.

As described above, the power transmission paths can be switched therebetween by operating the first and second clutches 351 and 352.

Reference Signs List

2: Electric motor

22: First output shaft

3: Transmission

31: First gear train

32: Second gear train

33: Input shaft

35: Switch part

36: Supply pathway

361: Inlet portion

6: Torque converter

10: Drive unit

100: Forklift

102: Lift device

103: Drive wheel

What is claimed is:

1. A forklift drive unit configured to be installed in a forklift, the forklift drive unit comprising:
an electric motor configured to drive and rotate a drive wheel; and
a transmission configured to change a speed of rotation of the electric motor at a variable gear ratio.

2. The forklift drive unit according to claim 1, wherein
the electric motor includes a first output shaft extending to a first side in an axial direction, and
the transmission includes a plurality of gear trains and a switch part, the switch part configured to switch a power transmission path between the plurality of gear trains.

3. The forklift drive unit according to claim 2, wherein the switch part is a multi-plate clutch.

4. The forklift drive unit according to claim 2, wherein the switch part overlaps with the electric motor as seen in a plan view.

5. The forklift drive unit according to claim 2, wherein
the transmission includes an input shaft and a supply pathway, the input shaft supporting the switch part, the input shaft extending in the axial direction, the supply pathway extending inside the input shaft in the axial direction, and
the supply pathway includes an inlet portion provided in an end of the input shaft, the end located on a second side in the axial direction.

6. The forklift drive unit according to claim 2, wherein
the plurality of gear trains include a first gear train and a second gear train, the second gear train lesser in gear ratio than the first gear train, and
the first gear train is disposed on the first side relative to the second gear train in the axial direction.

7. The forklift drive unit according to claim 6, wherein the switch part is disposed between the first gear train and the second gear train in the axial direction.

8. The forklift drive unit according to claim 2, wherein
the plurality of gear trains include a first gear train and a second gear train,
the switch part includes a first clutch and a second clutch, the first clutch configured to switch the power transmission path to the first gear train, the second clutch configured to switch the power transmission path to the second gear train, and
the transmission includes a first input shaft and a second input shaft, the first input shaft extending in the axial direction, the first input shaft receiving the first clutch attached thereto, the second input shaft extending in the axial direction, the second input shaft receiving the second clutch attached thereto.

9. The forklift drive unit according to claim 8, wherein
the first input shaft is disposed in front of the first output shaft, and
the second input shaft is disposed behind the first output shaft.

10. The forklift drive unit according to claim 8, wherein
the transmission includes a second output shaft to which a power is transmitted through the first gear train or the second gear train, and
the second output shaft is disposed between the first input shaft and the second input shaft in a back-and-forth direction.

11. The forklift drive unit according to claim 10, wherein the second output shaft is disposed below the first input shaft and the second input shaft.

12. The forklift drive unit according to claim 1, wherein the transmission includes a plurality of planetary gear mechanisms.

13. The forklift drive unit according to claim 1, wherein the transmission is disposed below the electric motor.

14. A forklift drive unit configured to be installed in a forklift, the forklift drive unit comprising:
an electric motor configured to drive and rotate a drive wheel; and
a torque converter configured to amplify a torque of the electric motor.

15. A forklift comprising:
the forklift drive unit according to claim 1;
a lift device; and
a drive wheel configured to be driven and rotated by the forklift drive unit.

16. A forklift comprising:
the forklift drive unit according to claim 14;
a lift device; and
a drive wheel configured to be driven and rotated by the forklift drive unit.
